(19) United States
(12) Patent Application Publication
(10) Pub. No.: US 2009/0218426 A1
(43) Pub. Date: Sep. 3, 2009

(54) HIGH SPEED ORBITING BALL MEDIA PROCESSORS

(76) Inventors: Chang-yu Wu, Gainesville, FL (US); Ki-Joon Jeon, Walnut Creek, CA (US); Alexandros D. Theodore, Plantation, FL (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 11/917,690

(22) PCT Filed: Jun. 30, 2006
(86) PCT No.: PCT/US06/25710

§ 371 Date: May 28, 2008

Related U.S. Application Data
(60) Provisional application No. 60/696,082, filed on Jun. 30, 2005.

(51) Int. Cl. B02C 17/04

(52) U.S. Cl. 241/176

(57) ABSTRACT

According to one embodiment, a ball mill for working generally spherically shaped target particles into a flake-shaped end product is provided. The ball mill includes a milling tube, one or more milling balls disposed within the milling tube, and a vibration source that is positioned and adapted to move the milling tube such that its central axis follows along a substantially circular path. The continuously changing direction of the acceleration of the milling tube results in each of the milling balls following a respective, substantially orbital path about the milling tube's central axis. As the milling balls follow the respective, orbital paths, the milling balls come into contact with and transform the target particles into flakes. In a further embodiment, the ball mill may further include a virtual particle separator configured to route intermediate particles back to an inlet portion of the milling tube for additional processing time.

### BACKGROUND OF THE INVENTION

Ball mills are currently used to work generally spherical target particles (e.g., metal particles) into an end product that is generally in the form of a flake (i.e., a particle that has a high diameter-to-thickness aspect ratio). The basic operation of exemplary prior art ball mills is described in U.S. Pat. No. 4,115,107 to Booz.

As may be understood from the Booz patent, such prior art ball mills include a cylindrical milling tube, a vibration mechanism for oscillating the tube longitudinally back and forth along the milling tube's central axis (i.e., the milling tube's axis of symmetry), and a plurality of milling balls that are used to grind target particles into the desired form. The vibratory motion of the milling tube within these prior art ball mills typically causes the milling balls to move in a generally chaotic manner within the milling tube and/or to move from one end of the milling tube to the other while the ball mill is in operation. Because the milling balls within a typical prior art ball mill tend to move longitudinally along the interior of the ball mill's milling tube while the ball mill is in operation, there is often a need to constantly re-circulate the milling balls from the trailing end of the milling tube to the leading end of the milling tube in order to assure a proper distribution of milling balls within the milling tube.

In addition, prior art ball mills often take a relatively long time (commonly several hours) to transform target particles into flakes. Furthermore, these prior art ball mills are not able to produce flakes with certain desired properties. Accordingly, there is a need for improved ball mills that may, for example, address one or more of the issues stated above.

### BRIEF DESCRIPTION OF THE SEVERAL VIEWS OF THE DRAWINGS

Various embodiments of the invention will now be described with reference being made to the accompanying drawings, which are not necessarily drawn to scale, and wherein:

FIG. 1 is a schematic diagram of a single batch milling machine according to a particular embodiment of the invention.

FIG. 2 is a diagram showing the general motion of a milling tube and multiple milling balls according to a particular embodiment of the invention.

FIG. 3 is a time lapse photograph showing the motion of seven different milling balls as the milling balls move along orbital paths within a milling tube according to a particular embodiment of the invention.

FIGS. 4A-4D are schematic diagrams showing the progressive movement of a particular milling ball as the milling ball travels about a substantially orbital path within the interior of the milling tube of FIG. 1.

FIGS. 5A-5D are schematic diagrams showing the frame-by-frame movements of a milling tube simplified into four basic movements and the resulting movement of the milling ball of FIG. 1.

FIG. 6 is a schematic diagram of the direction of movement of the milling tube in a downward direction and the resulting location of the milling ball of FIG. 1.

FIG. 7 is a schematic diagram of a continuous process milling machine according to a particular embodiment of the invention.

FIG. 8 is a picture of 300 μm metal target particles before the particles are processed.

FIG. 9 is a picture of 300 μm metal particles after the particles have been processed by a milling machine according to a particular embodiment of the invention.

FIG. 10 is a picture of polymer target particles before the particles are processed.

FIG. 11 is a picture of polymer particles after the particles have been processed by a milling machine according to a particular embodiment of the invention.

FIG. 12 is a schematic diagram of the general process by which layered flakes are formed from particles within ball mills according to particular embodiments of the invention.

FIG. 13 is a picture of flake-to-flake welding of iron particles that have been processed according to a particular embodiment of the invention.

FIG. 14 is a picture of a cross-section of a magnesium particle that has been processed according to a particular embodiment of the invention for one minute.

FIG. 15 is a picture of a cross-section of a magnesium particle that has been processed according to a particular embodiment of the invention for two minutes.

FIG. 16 is a chart illustrating the particle size distributions of magnesium particles prior to being processed according to one embodiment of the invention.

FIG. 17 is a chart illustrating the particle size distributions of magnesium particles after being processed using a 25 mg milling ball according to one embodiment of the invention.

FIG. 18 is a chart illustrating the particle size distributions of magnesium particles after being processed using a 35 mg milling ball according to one embodiment of the invention.

### DETAILED DESCRIPTION OF THE INVENTION

The present inventions now will be described more fully hereinafter with reference to the accompanying drawings, in which some, but not all embodiments of the inventions are shown. Indeed, these inventions may be embodied in many different forms and should not be construed as limited to the embodiments set forth herein. Rather, these embodiments are provided so that this disclosure will satisfy applicable legal requirements. Like numbers refer to like elements throughout.

### Single Batch Milling Machine

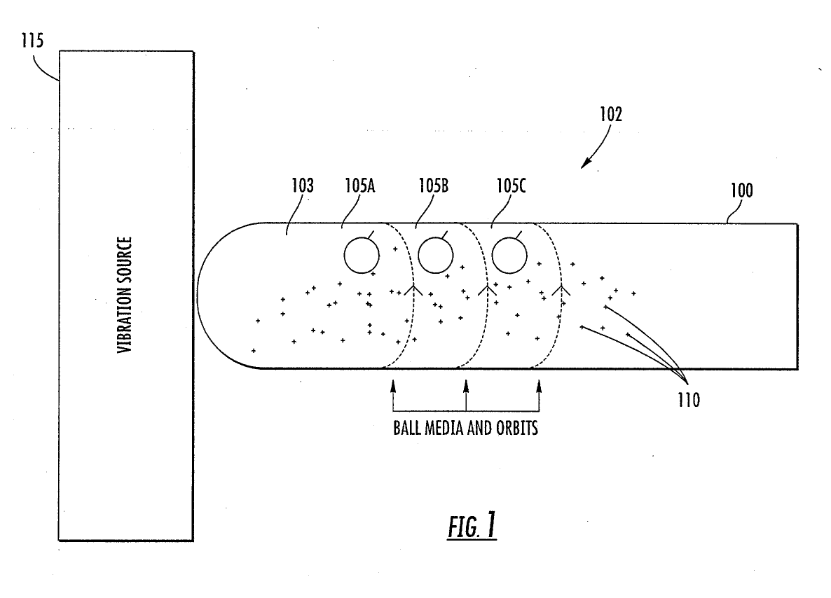

FIG. 1 depicts a single batch milling machine 102 according to a particular embodiment of the invention. As may be understood from this figure, in this embodiment, the milling machine 102 includes a substantially cylindrical milling tube 100 that defines a substantially cylindrical interior portion 103. The milling tube is dimensioned to house one or more (and preferably a plurality of) milling balls 105A-105C and target particles 110 to be processed by the milling machine 102. In various embodiments of the invention, the milling tube 100 is configured to be sealed during operation to prevent material from escaping from the milling tube 100 while the milling machine 102 is in use.

In various embodiments of the invention, the milling balls 105A-105C are substantially spherical, made of steel, and are between 3/16″ and ⅜″ in diameter. However, other milling balls of different materials and sizes may also be suitable for use within certain embodiments of the invention.

In various embodiments, the milling machine 102 further comprises a vibration source 115 that is adapted for vibrating the milling tube 100. This vibration source 115 is preferably configured to vibrate at a relatively high rate (e.g., greater than about 10,000, 12,000, 14,000 or 15,000 oscillations per minute), but may vibrate at any other suitable rate. One suitable vibration source 115 is the sheet Finish Sander (Model Number FS540K) by Black and Decker.

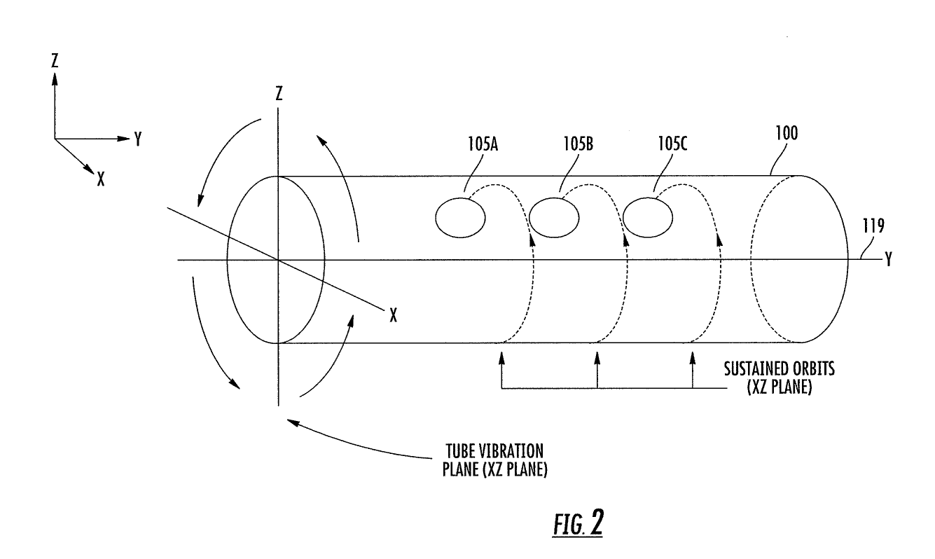

FIG. 2 is a diagram showing the general motion of the milling tube 100 and milling balls 105A-105C shown in FIG. 1. As may be understood from FIGS. 1 and 2, the vibration source 115 is configured to vibrate the milling tube 100 in a substantially circular pattern so that the central axis 119 of the milling tube 100 travels in a substantially circular path. For example, in one embodiment, the milling tube 100 is configured to rest in a home position when the milling tube 100 is not being vibrated by the vibration source 115. When the milling tube 100 is in this position, the milling tube's central axis 119 is in a “central axis home position.” However, in various embodiments, when the ball mill 102 is in use, the vibration source 115 moves the milling tube 100 in a substantially circular pattern so that the central axis 119 of the milling tube 100 travels in a substantially circular path about the home position of the ball milling tube's central axis.

The circular movement of the milling tube 100 is depicted generally by the arrows shown on the left side of FIG. 2. As may be understood from this figure, in this embodiment, the vibration source 115 is adapted to produce a vibration within a particular tube vibration plane (here, the XZ plane) and to thereby vibrate the milling tube 100 in a direction that is perpendicular (or substantially perpendicular) to the milling tube's central axis 119.

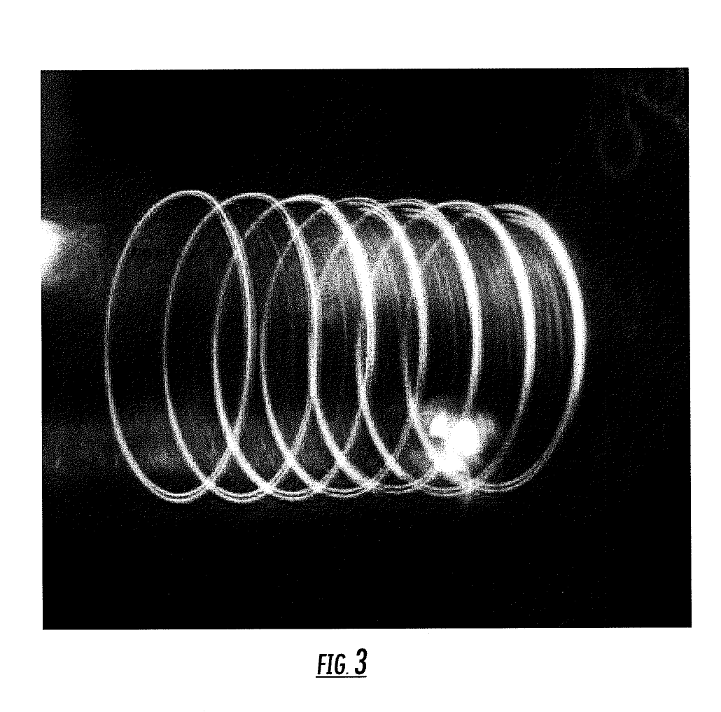

As may be understood from FIG. 2, as a result of the milling tube's circular vibration, the various milling balls 105A-105C disposed within the milling tube 100 travel about a substantially circular path along the milling tube's interior surface. In various embodiments of the invention, at least one (and preferably a plurality or all) of the milling balls 105A-105C travel along a circular path that lies substantially within a plane that is substantially perpendicular to the milling tube's central axis. FIG. 3 is a time lapse photograph showing seven milling balls traveling along such a path. In this photograph, each circle shows the path of travel of a particular milling ball.

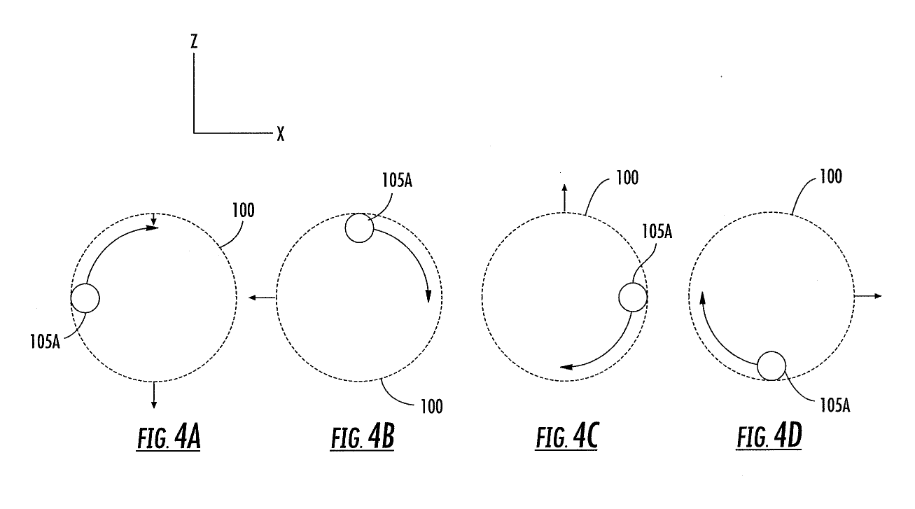

The progressive movement of a particular milling ball 105A according to certain embodiments of the invention is depicted in FIGS. 4A-4D. As may be understood from these figures, in various embodiments, the vibration of the milling tube 100 is timed so that, at any particular point in time, the milling tube 100 moves in a direction that is substantially opposite to the ball's current immediate direction of travel. For example, as shown in FIG. 4A, when the milling ball 105A is disposed adjacent the leftmost interior surface of the milling tube 100: (1) the milling ball 105A travels in a substantially upward vertical direction; and (2) the milling tube 100 travels in a substantially downward vertical direction. As shown in FIGS. 4B-4D, this moving relationship between the milling ball 105A and the milling tube 100 is repeated as the milling ball 105A travels around the interior surface of the milling tube 100.

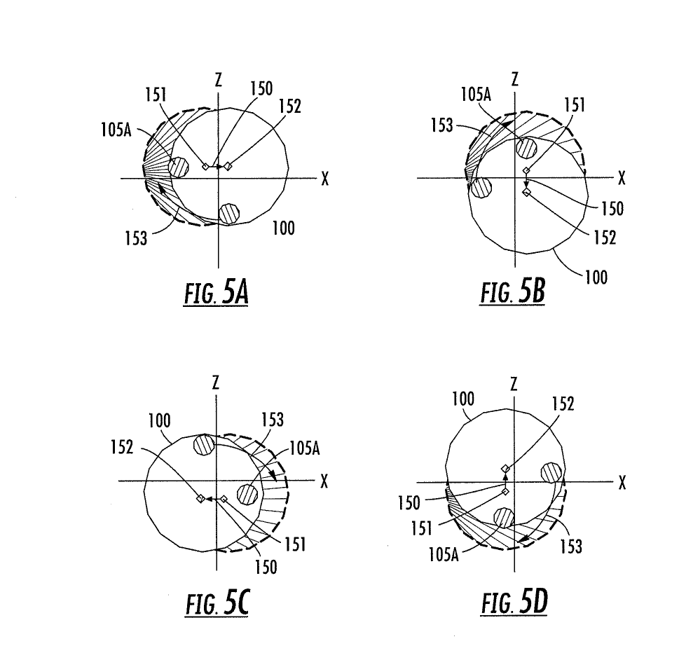

FIGS. 5A-5D further illustrate the progressive movement of the particular milling ball 105A according to certain embodiments of the invention. In particular, FIGS. 5A-5D are simplified illustrations of the basic, cyclical movements of the milling tube 100 taken at four different points during a single oscillation of the milling tube 100. These figures also show the resulting movement of the milling ball 105A.

It is noted that FIGS. 5A-5D show the progressive motion of the milling tube 100 and milling ball 105A in relation to the fixed X and Z axes shown in these figures. In each of these figures, the general motion of the milling tube 100 is indicated by the smaller, central, gray arrow 150. For example, in FIG. 5B, the central gray arrow 150 indicates that the milling tube 100 moves vertically downwardly so that the milling tube's central axis moves from a first vertical position 151 (shown in gray) to a second vertical position 152 (shown in black) that is vertically below the first vertical position 151.

In each of FIGS. 5B-5D, the respective intial positions of the milling tube 100 and milling ball 105A (which are shown in gray) correspond to the respective end positions of the milling tube and milling ball (which are shown in black) shown in the previous drawing. For example, the gray milling tube and milling ball positions shown in FIG. 5B correspond to the black milling tube and milling ball positions shown in FIG. 5A. Similarly, the gray milling tube and milling ball positions shown in FIG. 5C correspond to the black milling tube and milling ball positions shown in FIG. 5B, and the gray milling tube and milling ball positions shown in FIG. 5D correspond to the black milling tube and milling ball positions shown in FIG. 5C.

By the same token, because, in various embodiments, the milling tube 100 and milling ball 105A continuously circulate in sequence through the positions shown in FIGS. 5A-5D, the gray milling tube 100 and milling ball 105A positions shown in FIG. 5A correspond to the black milling tube and milling ball positions shown in FIG. 5D.

The motion of the milling tube 100 and milling ball 105A according to the particular embodiment of the invention shown in FIGS. 5A-5D will now be discussed in greater detail. As may be understood from FIG. 5A, in one embodiment, the milling tube 100 first moves from: (1) a first position in which the central axis of the milling tube 100 is in the upper left-hand quadrant of the X-Z axis shown in FIGS. 5A-5D; to (2) a second position in which the central axis of the milling tube 100 is in the upper right-hand quadrant of the X-Z axis shown in FIGS. 5A-5D. This movement causes the milling ball 105A to roll along the interior of the milling tube 100 from: (1) a first position in which the milling ball 105A is adjacent the bottom interior portion of the milling tube 100 (e.g., adjacent, and/or on, a portion of the Z axis) to (2) a second position adjacent the left-hand side of the milling tube 100 (e.g., adjacent, and/or on, a portion of the X axis).

Next, as shown in FIG. 5B, the milling tube 100 moves from the second position to a third position in which the central axis of the milling tube 100 is in the lower right-hand quadrant of the X-Z axis shown in FIGS. 5A-5D. This movement causes the milling ball 105A to roll along the interior of the milling tube 100 from the second position described above to a third position that is adjacent the top interior portion of the milling tube 100 (e.g., adjacent, and/or on, a portion of the Z axis).

Next, as shown in FIG. 5C, the milling tube 100 moves from the second position to a third position in which the central axis of the milling tube 100 is in the lower left-hand quadrant of the X-Z axis shown in FIGS. 5A-5D. This movement causes the milling ball 105A to roll from the third position described above to a fourth position in which the milling ball 105A is adjacent the right-hand interior portion of the milling tube 100 (e.g., adjacent, and/or on, a portion of the X axis).

As shown in FIG. 5D, the milling tube 100 then moves from the third position described above to a fourth position in which the central axis of the milling tube 100 is in the upper left-hand quadrant of the X-Z axis shown in FIGS. 5A-5D. This movement causes the milling ball 105A to roll from the fourth position described above to the first position described above (in which the milling ball 105A is adjacent the bottom interior portion of the milling tube 100 (e.g., adjacent, and/or on, a portion of the Z axis). The milling tube 100 then preferably repeats the sequential movement shown in FIGS. 5A-5D until the desired milling results are reached.

In various embodiments of the invention, the central axis of the milling tube 100 follows an essentially square-shaped path as the milling tube 100 moves between the first, second, third and fourth positions discussed above. For example, in various embodiments, as shown in FIG. 5B, as the milling tube 100 moves from the first to the second position, the milling tube's central axis moves to the right a first predetermined distance along a substantially horizontal path. Similarly, as shown in FIG. 5C, as the milling tube 100 moves from the second to the third position, the milling tube's central axis moves downwardly a second predetermined distance along a substantially vertical path. By the same token, as shown in FIG. 5D, as the milling tube 100 moves from the third to the fourth position, the milling tube 100 moves to the left a third predetermined distance along a substantially horizontal path. Similarly, as shown in FIG. 5A, as the milling tube 100 moves from the fourth to the first position, the milling tube 100 moves upwardly a fourth predetermined distance along a substantially vertical path. In a particular embodiment the first, second, third, and fourth predetermined distances referenced above are substantially the same.

In various embodiments, the repeated circular oscillations of the milling tube 100 cause an acceleration with a continuously changing direction away from the central axis of the milling tube, which is indicated by a gray arrow 153. In turn, this acceleration naturally causes the milling ball 105A to move (and preferably roll) to the opposite-most point from the direction of movement of the milling tube 100. This opposite-most point is indicated by the black position of the milling ball 105A.

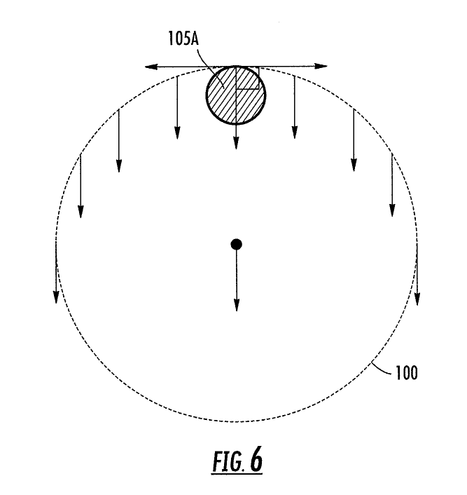

As shown in FIG. 6, the milling ball 105A is aligned with the direction of acceleration such that the tangential line drawn at the ball's contact with the milling tube 100 is substantially perpendicular to the milling tube's direction of acceleration. However, to sustain the orbiting motion, it is preferable that this alignment not be disturbed by significant external forces (e.g., external forces outside certain small leniencies).

With a continuous change in the direction of the acceleration of the milling tube 100, the position of the milling ball 105A likewise changes continuously. Ultimately, this motion causes the milling ball 105A to roll along (and preferably not slide along) the inside interior surface of the milling tube 100 at substantially the same frequency as the oscillation of the milling tube 100.

In various embodiments of the invention, at least two (and preferably all) of the milling balls 105A-105C orbit along the interior surface of the milling tube 100 at substantially the same rate (as measured, for example, in rotations per minute). In addition, in certain embodiments, the ball mill 102 is configured so that: (1) a first milling ball 105A follows a first respective, substantially orbital path about the central axis of the milling tube 100; and (2) a second milling ball 105B follows a second respective, substantially orbital path about the central axis of the milling tube 100; and (3) as the first milling ball 105A follows the first orbital path and the second milling ball 105B follows the second orbital path, the first and second milling balls 105A, 105B are maintained in a substantially aligned relationship along a line that is substantially parallel to the central axis of the milling tube 100. In various embodiments: (1) a third milling ball 105C follows a third respective, substantially orbital path about the central axis of the milling tube 100; and (3) as the first milling ball 105A follows the first orbital path, the second milling ball 105B follows the second orbital path, and the third milling ball 105C follows the third orbital path, the first, second, and third milling balls 105A, 105B, 105C are maintained in a substantially aligned relationship along a line that is substantially parallel to the central axis of the milling tube 100.

To use a milling tube 100 according to this embodiment of the invention, a user first unseals the milling tube 100 and places one or more (and preferably a plurality of) milling balls 105A-105C and target particles 110 to be milled into the milling tube's interior 103 (see FIG. 1). The user then seals the milling tube 100. Next, the user activates the vibration source 115, which causes the milling balls 105A-105C to travel in a substantially circular path along the milling tube's interior surface as described above, and as shown generally by the dashed arrows in FIG. 1. In the meantime, the target particles 110 are forced against the milling tube's interior surface due to the circular motion of the milling tube 100. As the milling balls 105A-105C travel along the milling tube's interior surface, the milling balls 105A-105C forcibly roll over the various target particles. Over time, this serves to work each of the various target particles 110 into the form of a flake.

After a pre-determined period of time, the vibration source 115 is stopped, the milling tube 100 is unsealed, and the resulting flake product is removed from the milling tube 100.

### Continuous Process Milling Machine

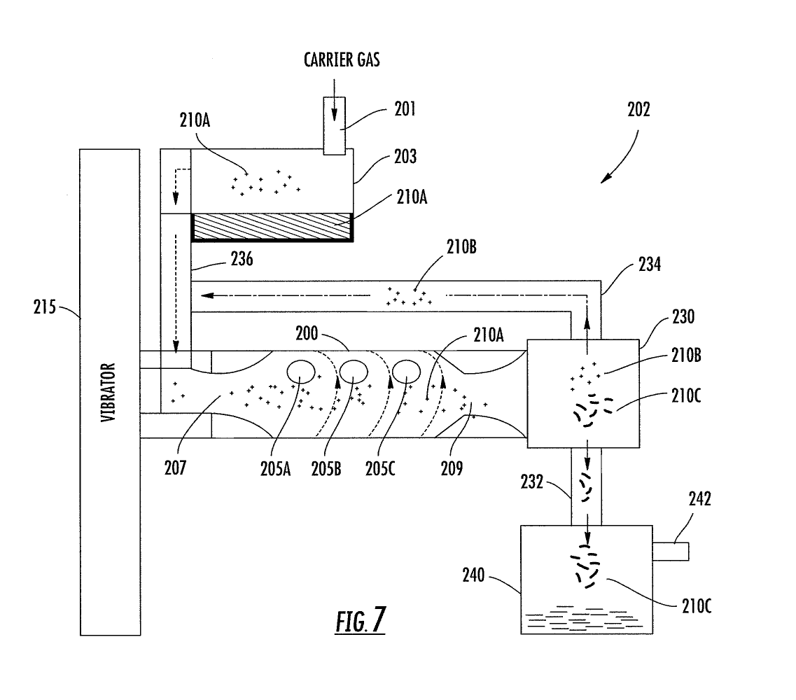

FIG. 7 depicts a continuous-process milling machine 202 according a particular embodiment of the invention. In this embodiment, the milling machine 202 includes a milling tube 200 and vibration source 215 that are configured to operate generally in the manner described above in regard to the single-batch milling machine 100 of FIG. 1. However, in this embodiment, the milling machine 202 further comprises a target particle loading bed 203 that is in gaseous communication with an inlet portion 207 of the milling tube 200 (e.g., via a target particle inlet tube 236).

In this embodiment, the milling machine 202 further comprises a virtual particle separator 230 that is in gaseous communication with the milling tube's outlet portion 209, the milling machine's target particle inlet tube 236, and a flake product storage bin 240. In various embodiments of the invention, the virtual separator 230 is attached adjacent the milling tube's outlet 209, and is adapted to separate finished flake particles from intermediate particles (e.g., based on the aerodynamic characteristics of the particles). The virtual separator 230 is also preferably configured: (1) to route intermediate particles 210B back to the milling tube's inlet portion 207 (e.g., via an intermediate particle recycling passage 234) for further processing within the milling tube 200; and (2) to route finished flake particles 210C into the flake product storage bin 240 (e.g., via a finished particle outlet 232) for later pickup by a user.

To use the continuous-process milling machine 202 shown in FIG. 7, a user first loads target particles 210A into the milling machine's target particle loading bed 203 and then activates the milling machine 202. Once the milling machine 202 is activated, the vibration source 215 begins to vibrate as described above and a carrier gas begins to flow from a carrier gas inlet 201 and into the target particle loading bed 203. The carrier gas then carries target particles 210A from the target particle loading bed 203 through the particle inlet tube 236, through the milling tube's inlet 207, and into the interior portion of the milling tube 200.

Next, the target particles 210A are forced against the milling tube's interior surface due to the circular motion of the milling tube 200. Meanwhile, the milling balls 205A-205C travel along the milling tube's interior surface and, in the process, forcibly roll over the various target particles 210A. Over time, this serves to flatten each of the target particles into the form of a flake.

As the milling tube 200 continues to rotate, the target particles 210A move slowly toward the milling tube's outlet 209. During this process, the target particles 210A are flattened further by the various milling balls 205A-205C.

After the various target particles 210A exit the milling tube's outlet 209, the target particles 210A enter the virtual separator 230, which: (1) routes finished flake particles 210C into the flake product storage bin 240 (e.g., though the finished particle outlet 232); and (2) routes intermediate particles 210B back to the inlet 207 of the milling tube 200 (e.g., via the particle recycle passage 234) for further processing. The process above may continue, for example, until the milling machine 202 produces the desired amount of flake product.

### Appearance of Particles and Resulting Flakes

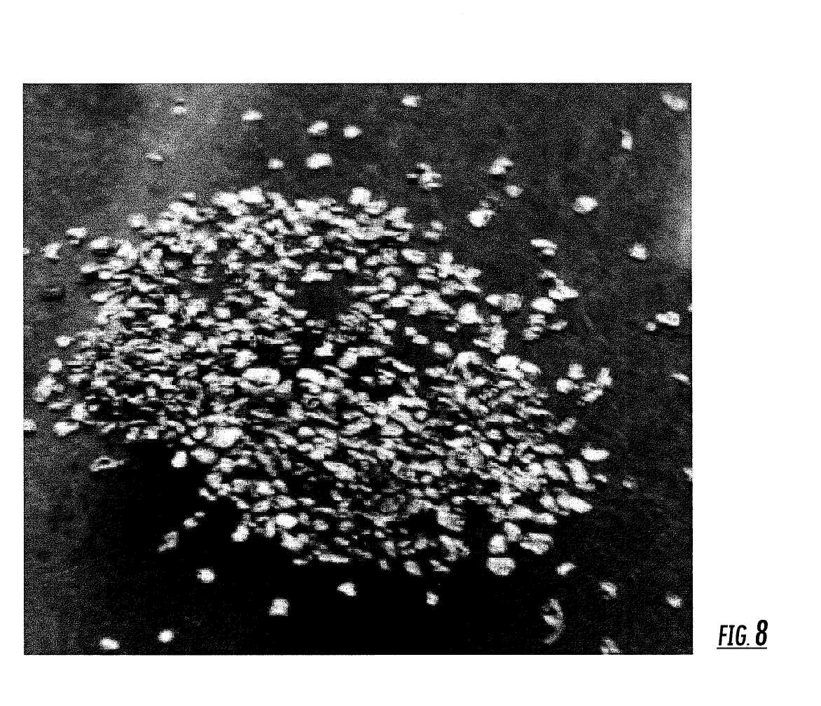

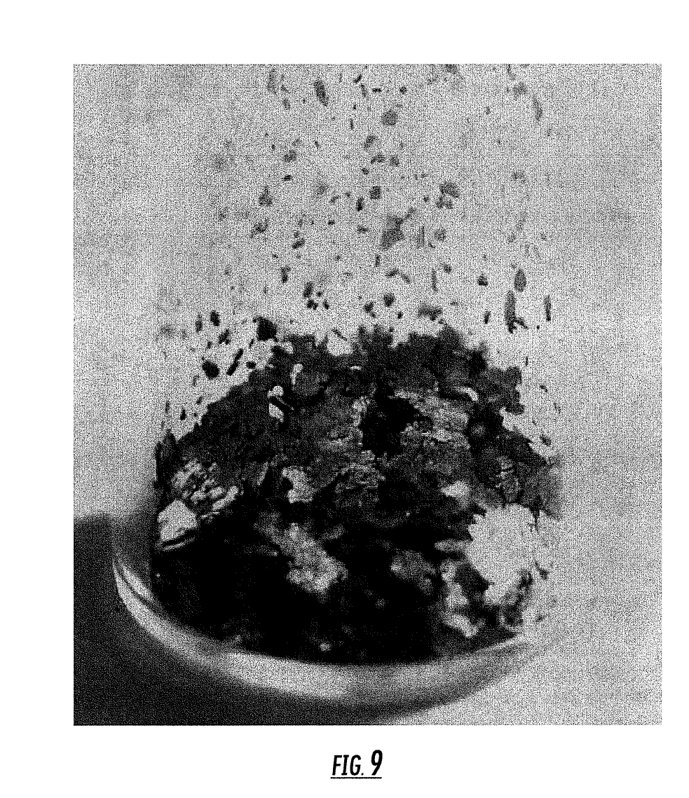

FIG. 8 is a picture of 300 μm metal particles before the particles are processed. FIG. 9 is a picture of 300 μm metal particles after the particles have been processed by a milling machine according to a particular embodiment of the invention.

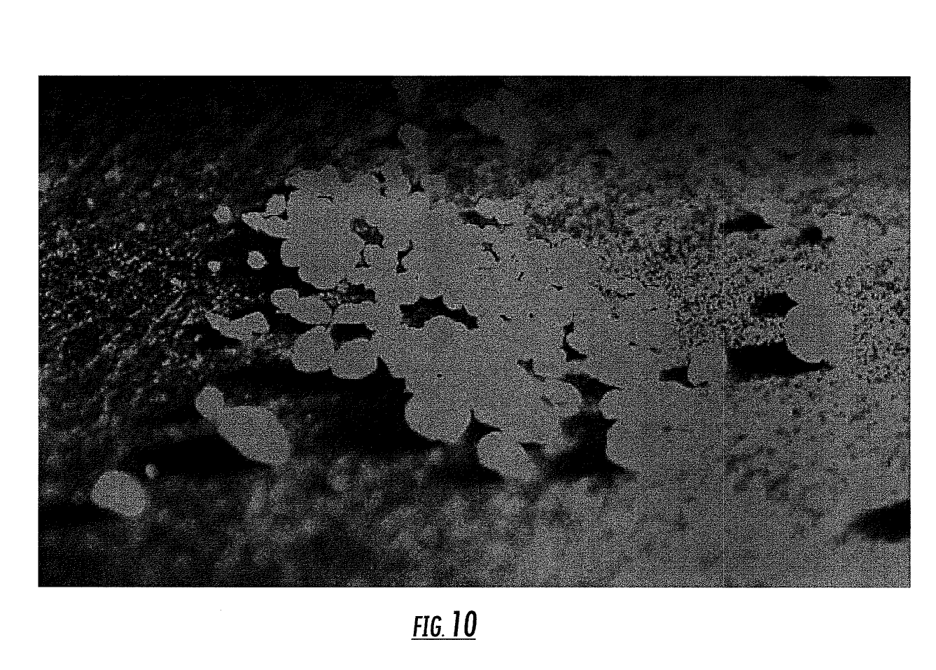

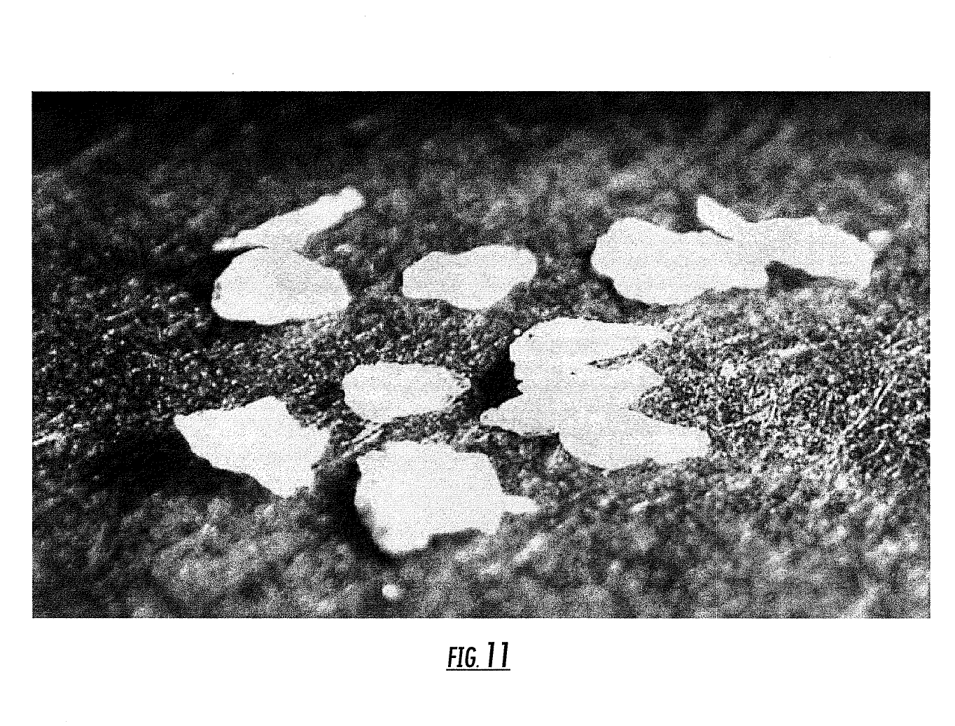

FIG. 10 is a picture of polymer particles before the particles are processed. FIG. 11 is a picture of this same type of polymer particles after the particles have been processed by a milling machine according to a particular embodiment of the invention.

### Production of Layered Flakes

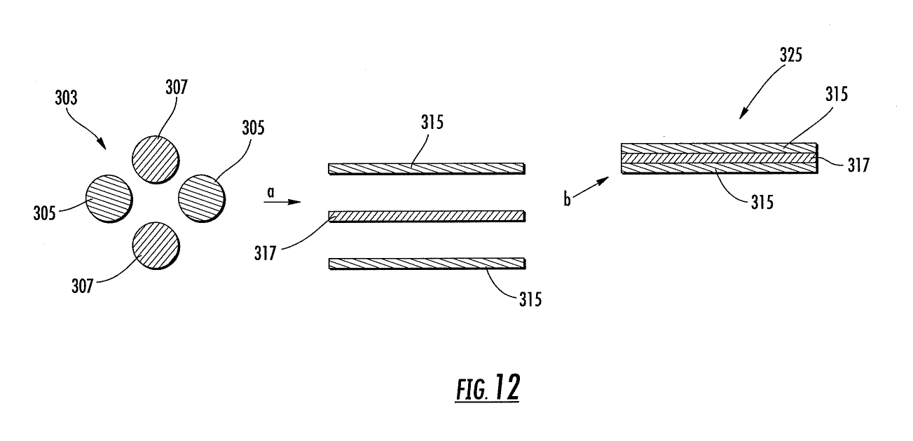

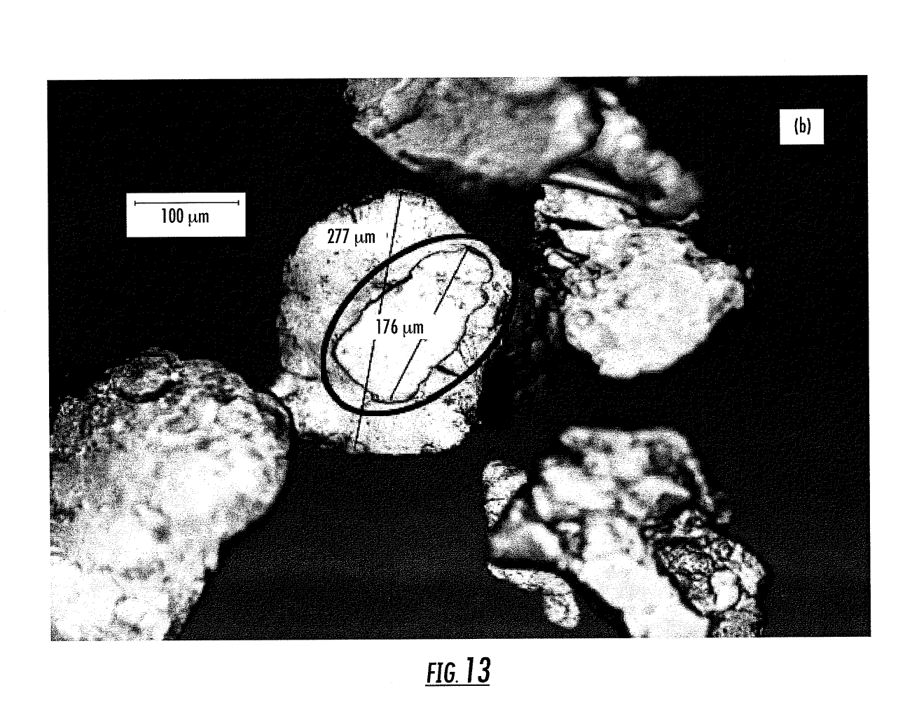

FIG. 12 is a schematic representation showing how milling machines according to various embodiments of the invention may be used to produce layered flakes through the mechanical alloying of a binary alloy mixture. In such embodiments, a mixture of loose target particles 303 is placed into a milling tube 100, 200 and processed as described above. During the milling process, the individual target particles 305, 307 first undergo plastic deformation and are flattened into flakes 315, 317. The flakes 315, 317 are then bound together (e.g., via coalescence or welding effect) into a single flake 325 having alternating layers of material as shown in FIG. 12. This technique can be used to produce layered flakes having a variety of different properties. Such flakes may, for example, be useful in hydrogen storage applications, fuel cell electrode production, and in pharmaceutical production (such layered flakes can facilitate the expedited, simultaneous delivery of multiple drugs). FIG. 13 further illustrates exemplary flake-to-flake welding according to one embodiment of the invention using iron particles. In this embodiment, loose flakes of iron are joined with other loose flakes of iron. However, in an alternative embodiment, layered flakes of different materials can also be made by forming flakes using different starting materials.

### Exemplary Operation of a Milling Mechanism

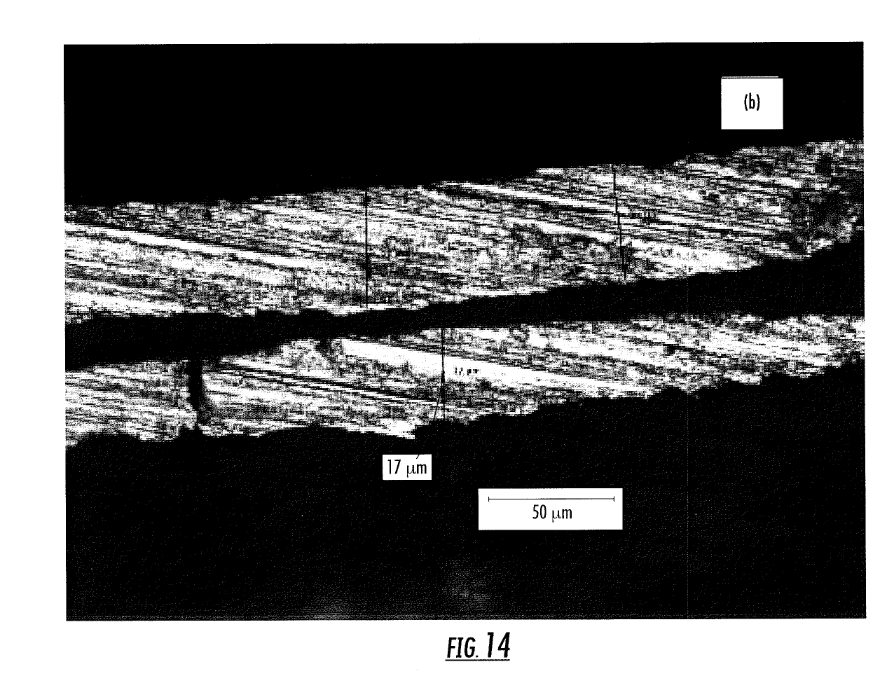

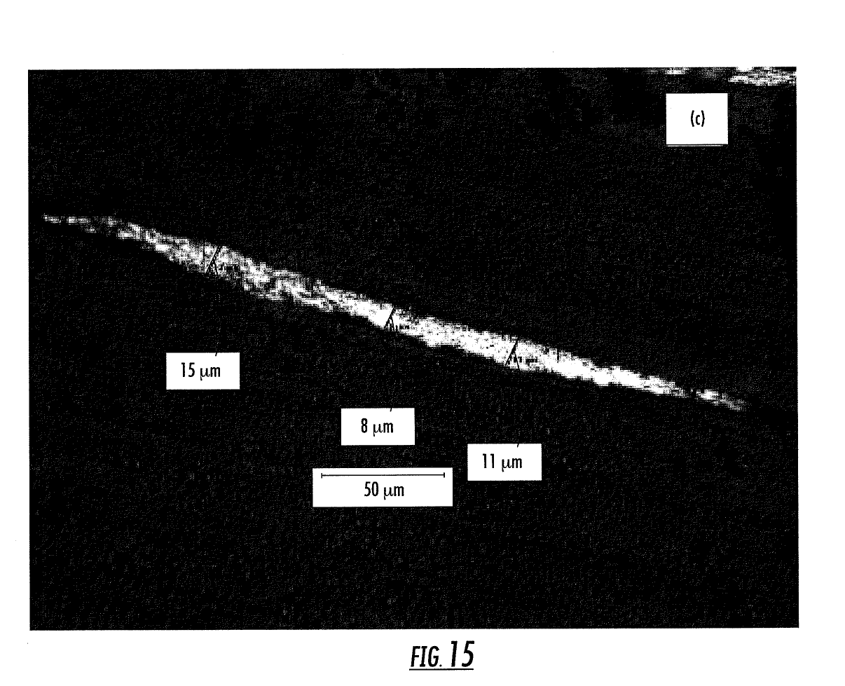

In an exemplary operation of a milling mechanism according to one embodiment of the invention, the mechanism's flake producing capability is measured by determining how quickly a spherical target particle can be processed into a flake of a particular thickness. For example, in one embodiment in which the mechanism utilizes milling tube having a diameter of between about 8 mm and about 12 mm, a milling ball having a diameter of between about 4 mm and about 8 mm, a milling radius of between about 1 mm and about 3 mm, and a milling speed of between about 10,000 RPM and 15,000 RPM. In a particular example in which the mechanism utilizes a milling tube having a diameter of about 10 mm, a milling ball having a diameter of about 6 mm, a milling radius of about 1.5 mm, and a milling speed of about 13,000 RPM, an initially spherical Magnesium particle of 300 μm is processed into a 12 μm mean-thickness flake in approximately two minutes. A cross-sectional view of the example Magnesium flake cast in a solid epoxy after approximately one minute of processing is shown in FIG. 14, and a cross-sectional view of the example flake after approximately two minutes of processing is shown in FIG. 15.

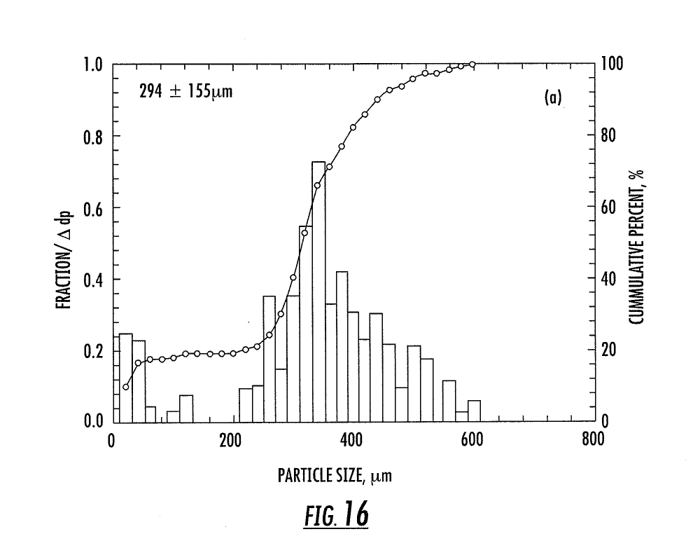

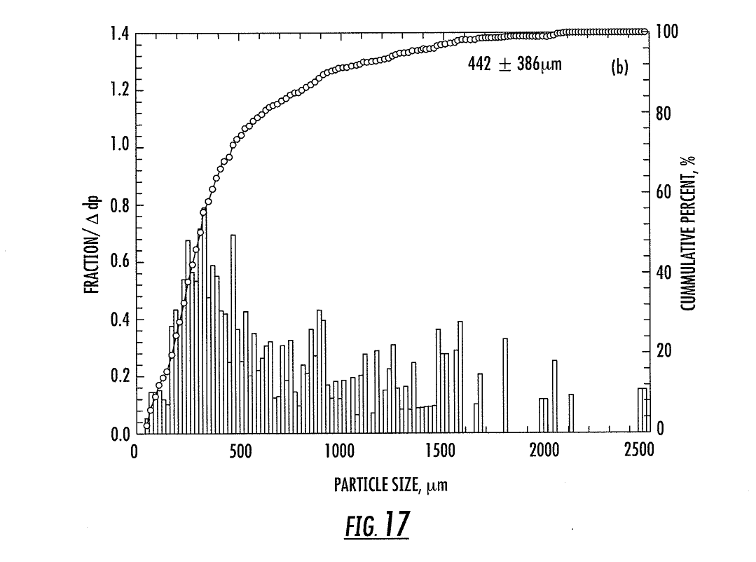

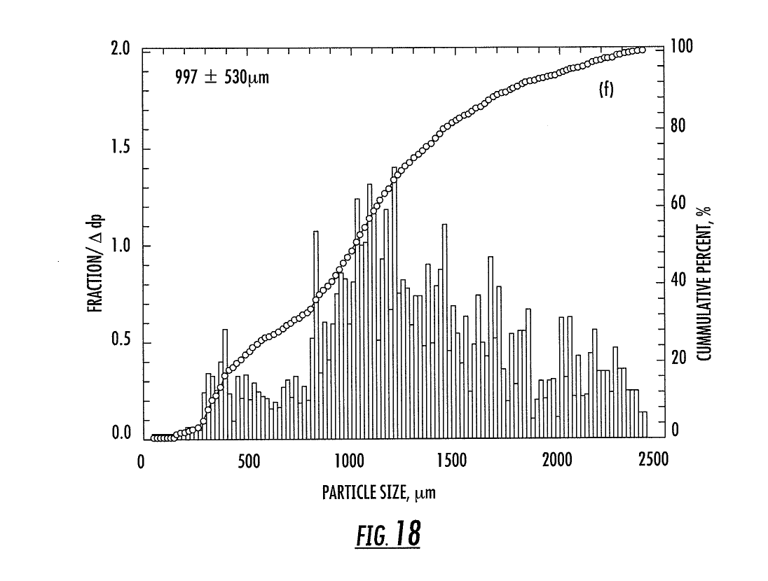

In addition, according to one embodiment, the particle morphology, or size, may be controlled in part by processing time and in part by other operating parameters. For example, the particle size distributions of Magnesium are shown before processing in FIG. 16, by changing the loading of the milling ball to about 25 mg and processing for approximately two minutes in FIG. 17, and by changing the loading of milling ball to about 35 mg and processing for approximately two minutes in FIG. 18. When the particle undergoes the process, the thickness reduces while the projected area increases. For example, as shown in FIGS. 17 and 18, the equivalent particle size becomes larger as the loading increases.

### CONCLUSION

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended listing of inventive concepts. Although specific terms are employed herein, they are used in a generic and descriptive sense only and not for purposes of limitation.

1. A ball mill comprising:
a milling tube defining an interior portion and a central axis;
a first milling ball and a second milling ball disposed within said interior portion;
a vibration source positioned and adapted to move said milling tube along a predetermined path in a substantially cyclical manner, wherein:
said ball mill is configured so that in response to said vibration source moving said milling tube along said predetermined path in said substantially cyclical manner, each of said first milling ball and second milling ball follows a respective, substantially orbital path about said central axis of said milling tube;
said ball mill is configured so that, in response to said vibration source moving said milling tube along said predetermined path in said substantially cyclical manner, said first milling ball follows a first respective, substantially orbital path about said central axis of said milling tube;
said ball mill is configured so that, in response to said vibration source moving said milling tube along said predetermined path in said substantially cyclical manner, said second milling ball follows a second respective substantially orbital path about said central axis of said milling tube; and
said first and second orbital paths are (a) substantially parallel or (b) in a substantially aligned relationship along a line that is substantially parallel to said central axis of said milling tube.

2. The ball mill of claim 1, wherein,
said first and second orbital paths are substantially parallel.

3. The ball mill of claim 1, wherein,
said first and second orbital paths are in a substantially aligned relationship along a line that is substantially parallel to said central axis of said milling tube.

4. The ball mill of claim 1, wherein said ball mill is adapted so that the rate at which said first milling ball travels along said first orbital path is substantially equal to the rate at which said second milling ball travels along said second orbital path.

5. A ball mill comprising:
a milling tube defining an interior portion, said milling tube having a central axis;
one or more milling balls disposed within said interior portion; and
a vibration source positioned and configured to vibrate said milling tube along a path that is substantially perpendicular to said central axis,
wherein said ball mill is configured so that in response to said vibration source vibrating said milling tube along said path, each of said one or more milling balls follows a substantially orbital path about said central axis of said milling tube, wherein said path of said milling tube that is substantially perpendicular to said central axis comprises (a) a substantially square path or b) a substantially circular path.

6. The ball mill of claim 5, wherein said path of said milling tube that is substantially perpendicular to said central axis comprises a substantially square path.

7. The ball mill of claim 5, wherein said path of said milling tube that is substantially perpendicular to said central axis comprises a substantially circular path.

8. The ball mill of claim 5, wherein said vibration source is configured to vibrate said milling tube at a rate of at least 10,000 oscillations per minute.

9. A ball mill comprising:
a milling tube defining an interior portion said milling tube having a central axis;
one or more milling balls disposed within said interior portion; and
a vibration source positioned and configured to move the milling tube along a predetermined path in a substantially cyclical manner,
wherein said ball mill is configured so that, in response to said vibration source moving said milling tube along said predetermined path in said substantially cyclical manner, each of said one or more milling balls follows a substantially circular path that is within a plane of travel, said plane of travel being substantially perpendicular to said central axis.

10. The ball mill of claim 9, wherein said ball mill is further configured so that, in response to said vibration source moving said milling tube along said predetermined path in said substantially cyclical manner, said one or more milling balls rolls along a surface of said interior portion of said milling tube.

11. The ball mill of claim 10, wherein said ball mill is adapted so that the rate at which each of said one or more milling balls travels along said substantially circular path is substantially equal to the rate at which said milling tube travels along said predetermined path in said substantially cyclical manner.

12. A ball mill comprising:
a milling tube defining an interior portion, said milling tube having a central axis;
one or more milling balls disposed within said interior portion; and
a vibration source positioned and configured to vibrate said milling tube along a path that is substantially perpendicular to said central axis,
wherein said ball mill is configured so that in response to said vibration source vibrating said milling tube along said path, each of said one or more milling balls follows a substantially circular path that is within a plane of travel, said plane of travel being substantially perpendicular to said central axis.

13. The ball mill of claim 12, wherein said ball mill is further configured so that, in response to said vibration source moving said milling tube along said path that is substantially perpendicular to said central axis, each of said one or more milling balls moves along said substantially circular path in a direction substantially opposite to said milling tube's current immediate direction of travel.

14. The ball mill of claim 12, wherein:
said milling tube has a diameter of between about 8 mm and about 12 mm;
each of said one or more milling balls has a diameter of between about 4 mm and about 8 mm;
said vibration source moves said milling tube at an oscillation of between about 10,000 RPM and about 15,000 RPM; and
a milling radius of said central axis of said milling tube is between about 1 mm and about 3 mm.

15. The ball mill of claim 12, wherein:
said milling tube has a diameter of about 10 mm;
each of said one or more milling balls has a diameter of about 6 mm;
said vibration source moves said milling tube at an oscillation of about 13,000 RPM; and
a milling radius of said central axis of said milling tube is about 1.5 mm.

16. A ball mill comprising:
a milling tube defining an interior portion and a central axis;
one or more milling balls disposed within said interior portion;
a vibration source positioned and configured to vibrate said milling tube and to thereby cause said one or more milling balls to roll along an interior portion of said milling tube;
a virtual separator adapted to separate particles processed by said one or more milling balls based on aerodynamic characteristics of said particles;
said particles comprise intermediate particles and finished particles; and
said virtual separator is adapted to route said intermediate particles for recirculation through said milling tube and adapted to route said finished particles into a finished flake particle area.

17. (canceled)

18. The ball mill of claim 16, wherein:
said virtual separator is in gaseous communication with said finished flake particle area, an outlet portion of said milling tube, and an inlet portion of said milling tube, and
said virtual separator provides a flow of carrier gas through said inlet portion, said outlet portion, and said finished flake particle area to thereby transport said intermediate particles to said inlet portion.

19. (canceled)

20. The ball mill of 16, wherein:
said virtual separator is in gaseous communication with said finished flake particle area, an outlet portion of said milling tube, and an inlet portion of said milling tube, and
said virtual separator provides a flow of carrier gas through said inlet portion, said outlet portion, and said finished flake particle area to thereby transport said finished particles into said finished flake particle area.

21. The ball mill of claim 1, wherein said first and second orbital paths are (a) substantially parallel and (b) in a substantially aligned relationship along a line that is substantially parallel to said central axis of said milling tube.
